(19) United States
(12) Patent Application Publication
(10) Pub. No.: US 2016/0140480 A1
(43) Pub. Date: May 19, 2016

(54) Transportation Coordination System

(71) Applicant: ADP, LLC, Roseland, NJ (US)

(72) Inventors: Roberto Rodrigues Dias, Porto Alegre (BR); Jarismar Chaves da Silva, Porto Alegre (BR); Leandro Ricardo Eidelwein, Porto Alegre (BR); Leandro da Silva Bianchini, Porto Alegre (BR)

(21) Appl. No.: 14/546,555

(22) Filed: Nov. 18, 2014

(51) Int. Cl. G06Q 10/06; H04L 29/08; G06F 3/0484

(52) U.S. Cl. CPC G06Q 10/063114; G06F 3/04842; H04L 67/18

(57) ABSTRACT

A method and apparatus for coordinating ride sharing. A route is identified, by a computer system, between a starting location and an ending location for an event. Potential riders are selected, by the computer system, from employees in an organization from locations of the employees in the organization for the route, wherein the potential riders will attend the event. A set of riders are confirmed, by the computer system, from the potential riders for a driver of a vehicle in the employees for the route.

### BACKGROUND INFORMATION

1. Field

The present disclosure relates generally to an improved computer system, and in particular, to a method and apparatus for coordinating ride sharing using a computer system. Still more particularly, the present disclosure relates to a method and apparatus for coordinating ride sharing for people in an organization using a computer system.

2. Background

People sharing transportation may occur in the form of ride sharing. Ride sharing has many benefits. For example, with ride sharing, costs such as fuel, tolls, maintenance, and driving stress are reduced for the people who ride together. Ride sharing also has environmental benefits. For example, reduced carbon emissions, traffic congestion, road maintenance, and other environmental benefits may occur with ride sharing.

Although ride sharing has benefits, people may be less likely to use ride sharing for various reasons. For example, increased commute time, convenience, and riding with strangers may reduce the desirability of ride sharing. Further, finding people going to the same destination who want to use ride sharing to reach the destination at a particular time may be difficult to find.

Therefore, it would be desirable to have a method and apparatus that take into account at least some of the issues discussed above, as well as other possible issues.

### SUMMARY

In one illustrative embodiment, a method for coordinating ride sharing is provided. A route is identified, by a computer system, between a starting location and an ending location for an event. Potential riders are selected, by the computer system, from employees in an organization from locations of the employees in the organization for the route, wherein the potential riders will attend the event. A set of riders are confirmed, by the computer system, from the potential riders for a driver of a vehicle in the employees for the route.

In another illustrative embodiment, a computer system comprises a coordinator in the computer system. The coordinator identifies a route between a starting location and an ending location for an event. The coordinator further selects potential riders from employees in an organization from locations of the employees in the organization for the route. The potential riders will attend the event. The coordinator still further confirms a set of riders from the potential riders for a driver of a vehicle in the employees for the route.

In yet another illustrative embodiment, a computer program product for coordinating ride sharing comprises a computer readable storage media. The computer program product further comprises first program code, stored on the computer readable storage media, for identifying a route between a starting location and an ending location for an event. The computer program product still further comprises second program code, stored on the computer readable storage media, for selecting potential riders from employees in an organization from locations of the employees in the organization for the route. The potential riders are teammates who work together and will attend the event. The computer program product further comprises third program code, stored on the computer readable storage media, for confirming a set of riders from the potential riders for a driver of a vehicle in the employees for the route.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a transportation environment in accordance with an illustrative embodiment;

FIG. 2 is an illustration of information flow occurring in generating ride sharing for a route in the form of a block diagram in accordance with an illustrative embodiment;

FIG. 3 is an illustration of a block diagram of employee information in accordance with an illustrative embodiment;

FIG. 4 is an illustration of a graphical user interface for logging into a data processing system in accordance with an illustrative embodiment;

FIG. 5 is an illustration of a graphical user interface for specifying a search for ride sharing opportunities in accordance with an illustrative embodiment;

FIG. 6 is an illustration of a graphical user interface for specifying a search for ride sharing opportunities in accordance with an illustrative embodiment;

FIG. 7 is an illustration of a graphical user interface for selecting a set of riders for a ride sharing opportunity in accordance with an illustrative embodiment;

FIG. 8 is an illustration of a graphical user interface for displaying ride sharing information about a rider in accordance with an illustrative embodiment;

FIG. 9 is an illustration of a graphical user interface for displaying locations of potential riders in accordance with an illustrative embodiment;

FIG. 10 is an illustration of a graphical user interface for displaying messages in accordance with an illustrative embodiment;

FIG. 11 is an illustration of a graphical user interface for displaying messages in accordance with an illustrative embodiment;

FIG. 12 is an illustration of a graphical user interface for managing ride sharing opportunities in accordance with an illustrative embodiment;

FIG. 13 is an illustration of a flowchart of a process for coordinating ride sharing in accordance with an illustrative embodiment;

FIG. 14 is an illustration of a flowchart of a process for selecting potential riders in accordance with an illustrative embodiment;

FIG. 15 is an illustration of a flowchart of a process for selecting potential riders in accordance with an illustrative embodiment;

FIG. 16 is an illustration of a flowchart of a process for confirming a set of riders from potential riders in accordance with an illustrative embodiment;

FIG. 17 is an illustration of a flowchart of a process for logging in an employee to a transportation environment in accordance with an illustrative embodiment;

FIG. 18 is an illustration of a flowchart of a process for displaying route information in accordance with an illustrative embodiment;

FIG. 19 is an illustration of a flowchart of a process for cancelling ride sharing for a rider in accordance with an illustrative embodiment;

FIG. 20 is an illustration of a flowchart of a process for cancelling ride sharing for a driver in accordance with an illustrative embodiment; and

FIG. 21 is an illustration of a block diagram of a data processing system in accordance with an illustrative embodiment.

### DETAILED DESCRIPTION

The illustrative embodiments recognize and take into account one or more different considerations. For example, the illustrative examples recognize and take into account that although ride sharing may reduce costs for the riders that ride together in a vehicle, setting up ride sharing may be more difficult than desired. The illustrative examples recognize and take into account that that lack of convenience, lack of familiarity with other riders, difficulty in finding a group of riders for ride sharing, and other factors may reduce the use of ride sharing.

The illustrative embodiments recognize and take into account that using geolocation may increase the ability to find riders that may want to participate in ride sharing. Geolocation is the identification of the geographic location of a physical object in the real world. Also, the illustrative embodiments recognize and take into account that identifying riders for ride sharing may be more convenient and easier to perform when potential riders are from an organization.

The illustrative embodiments provide a method and apparatus for coordinating ride sharing. In one illustrative example, a computer system identifies a route between a starting location and an ending location for an event. The computer system selects potential riders from employees in an organization from locations of the employees in the organization for the route, wherein the potential riders will attend the event. The computer system confirms a set of riders from the potential riders for a driver of a vehicle for the route.

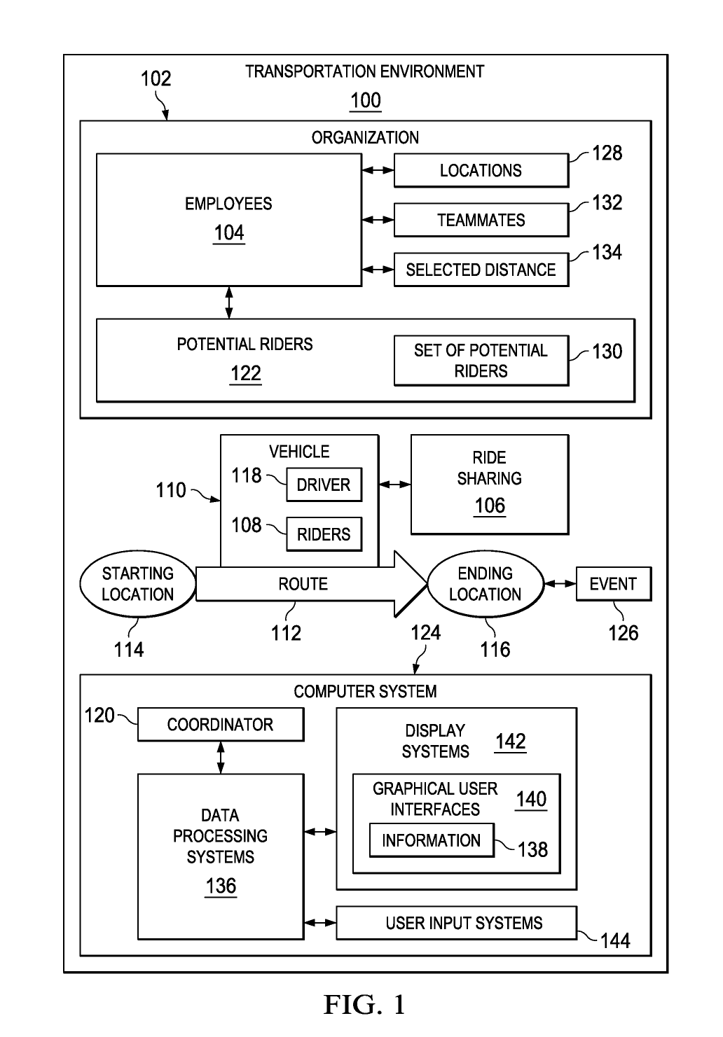

With reference now to the figures, and in particular, with reference to FIG. 1, an illustration of a block diagram of a transportation environment is depicted in accordance with an illustrative embodiment. In this illustrative example, transportation environment 100 includes organization 102. Organization 102 may be, for example, a company, a corporation, a partnership, a city, a charitable organization, a government agency, or some other suitable organization that has employees 104.

As depicted, organization 102 employs employees 104. Ride sharing 106 may occur between some or all of employees 104. In the illustrative example, ride sharing 106 is the movement of riders 108 in vehicle 110 on route 112 between starting location 114 and ending location 116.

Route 112 is a path followed by vehicle 110 in traveling from starting location 114 to ending location 116. Typically, route 112 follows a path defined by roads, parkways, highways, freeways, or other surfaces along which vehicle 110 travels.

In the illustrative example, driver 118 is an employee in employees 104 that drives vehicle 110 on route 112. Ride sharing 106 may be, for example, a carpool. With ride sharing 106, riders 108 may contribute to expenses. These expenses include, for example, at least one of fuel, toll fees, maintenance, or other travel related expenses. Additionally, with ride sharing 106, riders 108 may be able to travel on selected roads such as high occupancy vehicle (HOV) lanes.

In this illustrative example, vehicle 110 may be owned, leased, rented, or otherwise accessible for use by one of riders 108 or driver 118 for use in ride sharing 106. Vehicle 110 may be a car, a sport utility vehicle (SUV), a bus, or other suitable vehicle.

As depicted in this illustrative example, ride sharing 106 is coordinated by coordinator 120. In setting up ride sharing 106 for route 112, coordinator 120 identifies potential riders 122 from employees 104 in organization 102.

Potential riders 122 are employees 104 that may become riders 108 for ride sharing 106 on route 112 using vehicle 110 from starting location 114 to end location 116 as facilitated by coordinator 120. In particular, a potential rider in potential riders 122 is an employee that may be selected as a candidate to become a rider in riders 108. Some of employees 104 may choose not to participate in ride sharing 106 and are not selectable to be potential riders 122.

In the illustrative example, coordinator 120 is a component that may be implemented in software, hardware, firmware or a combination thereof. When software is used, the operations performed by coordinator 120 may be implemented in program code configured to run on hardware, such as a processor unit. When firmware is used, the operations performed by coordinator 120 may be implemented in program code and data and stored in persistent memory to run on a processor unit. When hardware is employed, the hardware may include circuits that operate to perform the operations in coordinator 120.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

In this illustrative example, coordinator 120 is implemented in computer system 124. Computer system 124 is a hardware system that includes one or more data processing systems. When more than one data processing system is present, those data processing systems may be in communication with each other using a communications medium. The communications medium may be a network. The data processing systems in computer system 124 may be selected from at least one of a computer, a server computer, a tablet, a mobile phone, or some other suitable data processing system.

During operation of coordinator 120, coordinator 120 coordinates the formation of ride sharing 106 in organization 102 for employees 104. For example, coordinator 120 may coordinate the formation of ride sharing 106 for route 112.

As depicted, coordinator 120 identifies route 112 between starting location 114 and ending location 116 for event 126. Starting location 114 and ending location may take various forms. For example, starting location 114, ending location 116 or both may be selected from one of a home, an office location, a parking garage, a restaurant, a client location, a convention center, a manufacturing facility, or some other suitable location.

Event 126 also may take various forms. For example, event 126 may be work, a seminar, lunch, a corporate retreat, returning home, or some other suitable event. In some illustrative examples, event 126 may be an event put on by organization 102, sponsored by organization 102, or otherwise related to or associated with organization 102. In other illustrative examples, event 126 may be initiated by at least one of riders 108 or driver 118.

In the illustrative example, coordinator 120 selects potential riders 122 from employees 104 in organization 102 from locations 128 of employees 104 in organization 102 for route 112. As depicted, potential riders 122 are employees 104 that will attend event 126. The locations may be selected from at least one of the current location of an employee, the location of an office of an employee, the location of the home of an employee, or some other suitable location.

In this illustrative example, coordinator 120 confirms set of potential riders 130 from potential riders 122 for route 112 for driver 118 of vehicle 110 for route 112. In this illustrative example, “a set of,” when used with reference to items, means one or more items. For example, set of potential riders 130 is one or more of potential riders 122. In this manner, ride sharing 106 is set up by coordinator 120 for driver 118 and riders 108.

As used herein, the phrase “at least one of,” when used with a list of items, means different combinations of one or more of the listed items may be used and only one of each item in the list may be needed. In other words, “at least one of” means any combination of items and number of items may be used from the list but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In the illustrative example, coordinator 120 may identify potential riders 122 based on potential riders 122 being teammates 132. Teammates 132 are employees 104 who work together. For example, teammates 132 may be employees 104 in the same department, group, project, division, committee, or other organizational structure in organization 102 where employees 104 work with each other.

As depicted, coordinator 120 may select potential riders 122 from employees 104 at locations 128 that are selected distance 134 from route 112. Selected distance 134 may be on route 112, a number of blocks from route 112, a milestone on route 112, or some other suitable distance from route 112. Additionally, potential riders 122 also may be selected as employees 104 that are teammates 132 in addition to being selected distance 134 from route 112.

During operation of coordinator 120, coordinator 120 coordinates setting up ride sharing 106 between employees 104. The coordination occurs through coordinator 120 communicating with data processing systems 136 in computer system 124. Data processing systems 136 are devices used by employees 104. For example, data processing systems 136 may be selected from at least one of a desktop computer, a laptop computer, a workstation, a tablet computer, a mobile phone, or some other suitable device.

In the illustrative examples, locations 128 of employees 104 may be identified using data processing systems 136. Locations 128 may be the locations of data processing systems 136. Locations 128 may be identified using global positioning system receivers, or other devices that generate location information about locations 128, or data processing systems 136. In this manner, locations 128 may be geolocations for employees 104. In particular, locations 128 may be current locations. Locations 128 may change as employees move while carrying data processing systems 136. In another illustrative example, locations 128 may change when employees move from one data processing system to another data processing system in data processing systems 136. As a result, the coordination of ride sharing 106 may be performed using locations 128 in the form of current locations for employees 104.

Additionally, coordinator 120 and data processing systems 136 may exchange information 138 to establish ride sharing 106 for route 112 using vehicle 110. Information 138 may be displayed in graphical user interfaces 140 in display systems 142 for data processing systems 136. Employees 104, such as potential riders 122, may visualize information 138 on graphical user interfaces 140 and interact with information 138 using user input systems 144 for data processing systems 136.

In the illustrative example, a display system in display systems 142 is a hardware system that includes one or more display devices for a data processing system in data processing systems 136. A display device may be selected from one of a liquid crystal display, a light emitting diode (LED) display, an organic light emitting diode (OLED) display, or some other suitable type of display device.

As depicted, a user input system in user input systems 144 is a hardware system that includes one or more user input devices. The user input device may be selected from one of a mouse, a keyboard, a trackball, a joystick, a touchpad, a touchscreen for a display device, or some other suitable type of user input device.

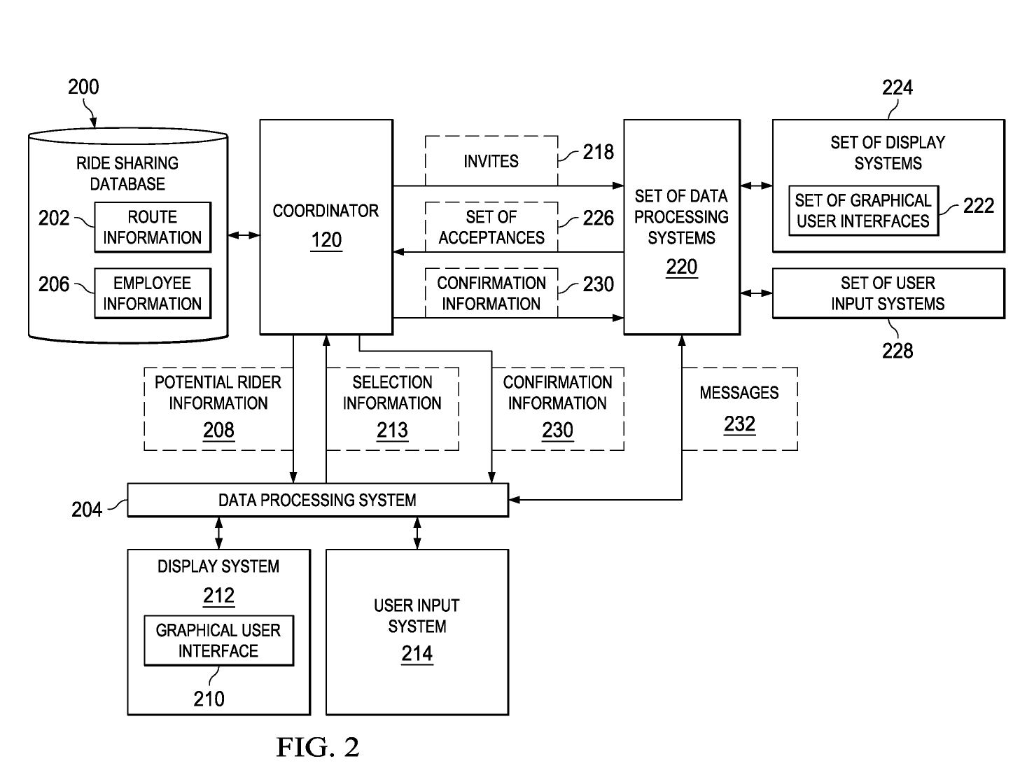

With reference next to FIG. 2, an illustration of information flow occurring in generating ride sharing for a route is depicted in the form of a block diagram in accordance with an illustrative embodiment. In the illustrative examples, the same reference numeral may be used in more than one figure. This reuse of a reference numeral in different figures represents the same element in the different figures.

The information flow illustrated in FIG. 2 involves coordinator 120 in computer system 124 and data processing systems 136 as shown in FIG. 1. In this illustrative example, an example of one manner in which information 138 may be exchanged within computer system 124 to generate ride sharing 106 for riders 108 from employees 104 in organization 102 from FIG. 1 is shown. In this illustrative example, coordinator 120 may access ride sharing database 200 when communicating with data processing systems 136 to establish ride sharing 106 for route 112 in FIG. 1.

As depicted in FIG. 1, coordinator 120 identifies route 112. The identification of route 112 may be in route information 202 stored in ride sharing database 200. Alternatively, route information 202 may be received from driver 118 using the data processing system 204 in data processing systems 136 in FIG. 1.

In this illustrative example, route information 202 includes at least one of departure times and locations of routes, arrival times and locations of routes, drivers of routes, sets of riders of routes, numbers of times drivers drove routes, numbers of times riders rode routes, ratings for the drivers of routes, or sets of ratings for the sets of riders of routes. As used herein, a rating for an employee for a route is an opinion about the employee selected by another employee about ride sharing for a route.

In the illustrative example, coordinator 120 identifies potential riders 122 from employees 104 in FIG. 1 using employee information 206 in ride sharing database 200. In this illustrative example, employee information 206 is for organization 102. Using employee information 206 to identify potential riders 122 may increase a comfort level, a level of security, or other desired effect by ride sharing 106 on route 112. By selecting potential riders 122 from employees 104 and excluding other persons who may be outside of organization 102, the comfort level of riders 108 may be increased for ride sharing 106 on route 112 in FIG. 1. This increase in comfort may be a result of riders 108 knowing that all of riders 108 are employees 104 of organization 102. In other words, ride sharing 106 may occur with a lower chance of an undesired person being present in riders 108.

Coordinator 120 in FIG. 1 sends potential rider information 208 to data processing system 204. Data processing system 204 displays potential rider information 208 in graphical user interface 210 in display system 212 for data processing system 204. In this manner, driver 118 may visualize potential riders 122 from the display of potential rider information 208.

As depicted, driver 118 may input selection information 213 as user input through user input system 214 for data processing system 204 that selects a set of potential riders 130 from potential riders 122 in FIG. 1 displayed in graphical user interface 210. Selection information 213 is sent from data processing system 204 to coordinator 120. With the selection of a set of potential riders 130, coordinator 120 sends set of invites 218 to set of data processing systems 220 in data processing systems 136 for potential riders 122 in set of potential riders 130. In this illustrative example, set of data processing systems 220 is part of data processing systems 136 in FIG. 1.

As depicted, set of invites 218 is displayed on set of graphical user interfaces 222 in set of display systems 224 for set of data processing systems 220. In this illustrative example, set of acceptances 226 is user input that may be received through set of user input systems 228 as to whether or which ones of set of invites 218 have been accepted. Set of acceptances 226 are received by coordinator 120 from set of data processing systems 220. With set of acceptances 226, coordinator 120 identifies riders 108 for ride sharing 106 for vehicle 110 driven by driver 118 on route 112 in FIG. 1. As part of the finalization, coordinator 120 sends confirmation information 230 to data processing system 204 and set of data processing systems 220.

Additionally, coordinator 120 also may coordinate messages 232. Messages 232 may be sent between at least one of data processing systems 136 in set of data processing systems 220 or data processing system 204 and set of data processing systems 220. Messages 232 may be used for communication between riders in riders 108 or between driver 118 and riders 108. For example, changes such as time changes, cancellations, or other matters may be communicated using messages 232. In the illustrative example, messages 232 may be used after ride sharing 106 has been established for route 112. In this manner, coordinator 120 may help facilitate communication between at least one of potential riders 122, riders 108, or driver 118 in FIG. 1.

In the illustrative example, messages 232 may take the form of real time messages. For example, messages 232 may be at least one of chat messages, instant messages, short message service (SMS) messages, text messages, or other suitable types of messages.

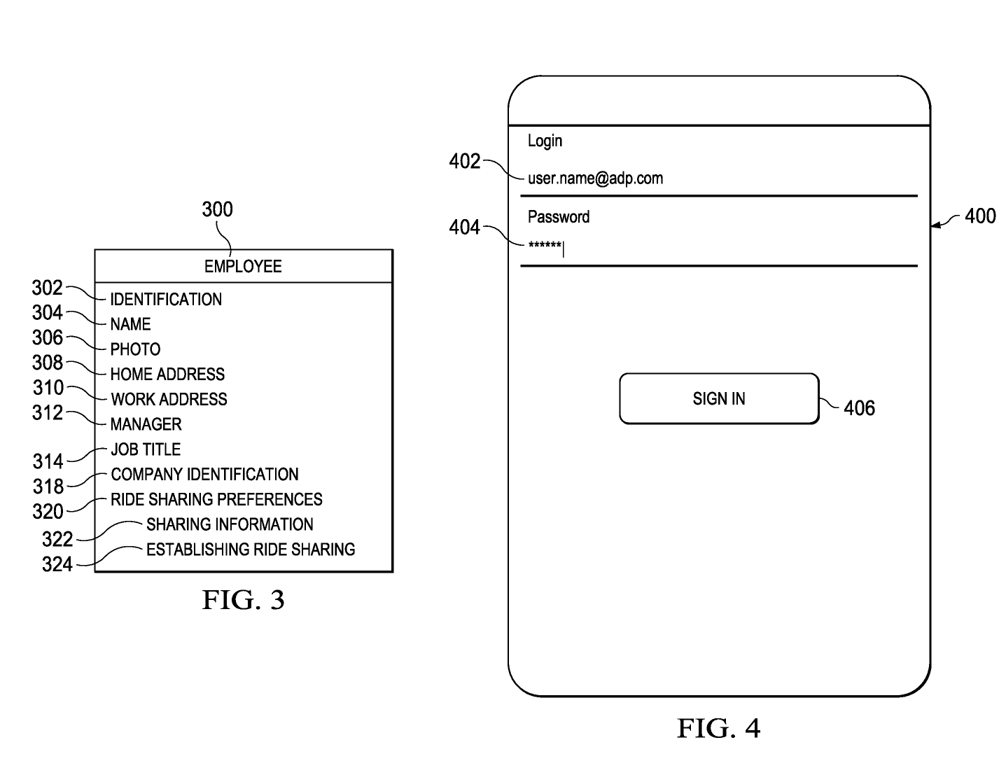

With reference next to FIG. 3, an illustration of a block diagram of employee information is depicted in accordance with an illustrative embodiment. In this depicted example, employee data structure 300 is an example of a data structure that holds information for an employee in employees 104 in FIG. 1. Employee data structure 300 is an example of a data structure that may be used to hold employee information 206 in FIG. 2.

In this illustrative example, employee data structure 300 includes a number of types of information. As depicted, employee data structure 300 includes the following types of information about an employee: employee identification 302, name 304, photo 306, home address 308, work address 310, manager 312, job title 314, company identification 318, and ride sharing preferences 320.

Employee identification 302 is a unique identifier for the employee. The unique identification of the employee by employee identification 302 may be within organization 102 in FIG. 1. For example, employee identification 302 may be a serial number, a social security number, or some other suitable identifier.

Name 304 is the name of the employee. Photo 306 may be a photograph of the employee. Home address 308 is the address for the residents of the employee. Work address 310 is an address identification location of where the employee works in the company. Manager 312 identifies the manager of the employee. Job title 314 is the job title for the employee. Company identification 318 identifies the company that the employee works for in this example. In some illustrative examples, ride sharing database 200 in FIG. 2 may include employee information for more than one organization.

In this illustrative example, ride sharing preferences 320 for an employee includes at least one of preferences for sharing information 322 for the number of types of information in employee data structure 300 or preferences for establishing ride sharing 324. As depicted, a preference in preferences for sharing information 322 for a type of information is at least one of a preference to share the type of information or a preference to keep the type of information anonymous. Keeping a type of information anonymous means the type of information is not displayed to other employees in transportation environment 100 in FIG. 1. For example, preferences for sharing information 322 may include a preference to keep photo 306 of employee anonymous by not displaying photo 306 to other employees using transportation environment 100.

In this illustrative example, preferences for sharing information 322 may include a preference to keep anonymous at least one of employee identification 302, name 304, photo 306, home address 308, work address 310, manager 312, job title 314, company identification 318, or ride sharing preferences 320. For example, this information may be information that the employee may wish to keep private and not disclose. Preferences for establishing ride sharing 324 for an employee may include at least one of an identification of the employee as at least one of a driver, a rider, or an employee that is just looking; an identification of selected distance 134 from route 112 in FIG. 1; an identification of when transportation will depart at the start of the route or arrive at the destination; or other suitable types of preferences for a user of transportation environment 100. An employee who is just looking is an employee who is not currently using transportation environment 100 to establish ride sharing. An employee who is just looking may view possible routes, and chat with other employees. The employee selects at least one of a driver or a rider before establishing ride sharing.

As a result, computer system 124 operates as a special purpose computer system in which at least one of coordinator 120 or data processing systems 136 in computer system 124 enable establishing ride sharing 106 for employees 104 in a more efficient manner that encourages the establishment of ride sharing 106 for route 112 in FIG. 1. In particular, at least one of coordinator 120 or data processing systems 136 transforms computer system 124 into a special purpose computer system as compared to currently available general computer systems that do not have at least one of coordinator 120 or data processing systems 136.

Computer system 124 performs a transformation of data changes such that the data has a different function or has a different use. For example, coordinator 120 transforms information in ride sharing database 200 from a first format for storing information in ride sharing database 200 to a second format that may be displayed in graphical user interfaces 140.

The display of this information is performed to provide a visualization for operators of data processing systems 136. This visualization is displayed in graphical user interfaces 140 in display systems 142 for data processing systems 136. The visualization aids in coordinating ride sharing 106 for route 112 in the illustrative example.

Additionally, with riders 108 and driver 118 being employees 104 in organization 102, other benefits may occur. For example, networking may occur during ride sharing 106. Also, discussions or work relating to event 126 also may occur during ride sharing 106. In this manner, a more efficient use of time and resources in organization 102 may occur through coordinator 120 coordinating ride sharing 106.

The illustration of transportation environment 100 and the different components in transportation environment 100 in FIGS. 1-3 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, ride sharing 106 may include one or more vehicles in addition to vehicle 110. Vehicle 110 may be used between starting location 114 and ending location 116 with driver 118 driving vehicle 110. Another driver in riders 108 or a new rider may become a driver of vehicle 110 or another vehicle at any starting location 114 to continue ride sharing along a new route. As a result, ending location 116 is a starting location for another segment occurring in ride sharing 106 in an illustrative example. In another illustrative example, another vehicle in place of vehicle 110 may be used somewhere between starting location 114 and ending location 116 such that the new vehicle carries riders 108 to ending location 116 on route 112.

In another illustrative example, employee data structure 300 may include other types of information in addition to or in place of the ones depicted. For example, preference information, travel times, routes, days of the week, or other suitable information may be included in employee data structure 300. In other illustrative examples, manager 312, or ride sharing preferences 320 may be omitted.

In still another illustrative example, employee information 206 may include information for one or more organizations in addition to organization 102. With this type of implementation, coordinator 120 may coordinate ride sharing 106 for employees of more than one organization. For example, ride sharing 106 on route 112 may include employees from two or more organizations.

FIGS. 4-12 are examples of graphical user interfaces that may be displayed in a display system for a data processing system to establish ride sharing for a route. The graphical user interfaces shown in these figures are examples of an implementation for a graphical user interface shown in block form in at least one of graphical user interfaces 140 in FIG. 1, graphical user interface 210 in FIG. 2, or set of graphical user interfaces 222 in FIG. 2.

With reference now to FIG. 4, an illustration of a graphical user interface for logging into a data processing system is depicted in accordance with an illustrative embodiment. Graphical user interface 400 is an example of a graphical user interface shown in block form in at least one of graphical user interfaces 140 in FIG. 1, graphical user interface 210 in FIG. 2, or set of graphical user interfaces 222 in FIG. 2.

As depicted, user input has been received in graphical user interface 400 for user name 402 and password 404. In this illustrative example, user input selecting sign in button 406 initiates an attempt to log user name 402 into a data processing system to establish ride sharing a route.

In the illustrative example, the attempt to login by a user may be successful when user name 402 is confirmed as an employee in employees 104 of organization 102 in FIG. 1. As depicted, if user name 402 and password 404 does not identify user name 402 as an employee in employees 104 of organization 102, then the attempt to login may be unsuccessful. When the login is successful, the employee is allowed to continue to establish ride sharing. When the login is not successful, the user is not allowed to continue past graphical user interface 400 to additional graphical user interfaces provided by the data processing system.

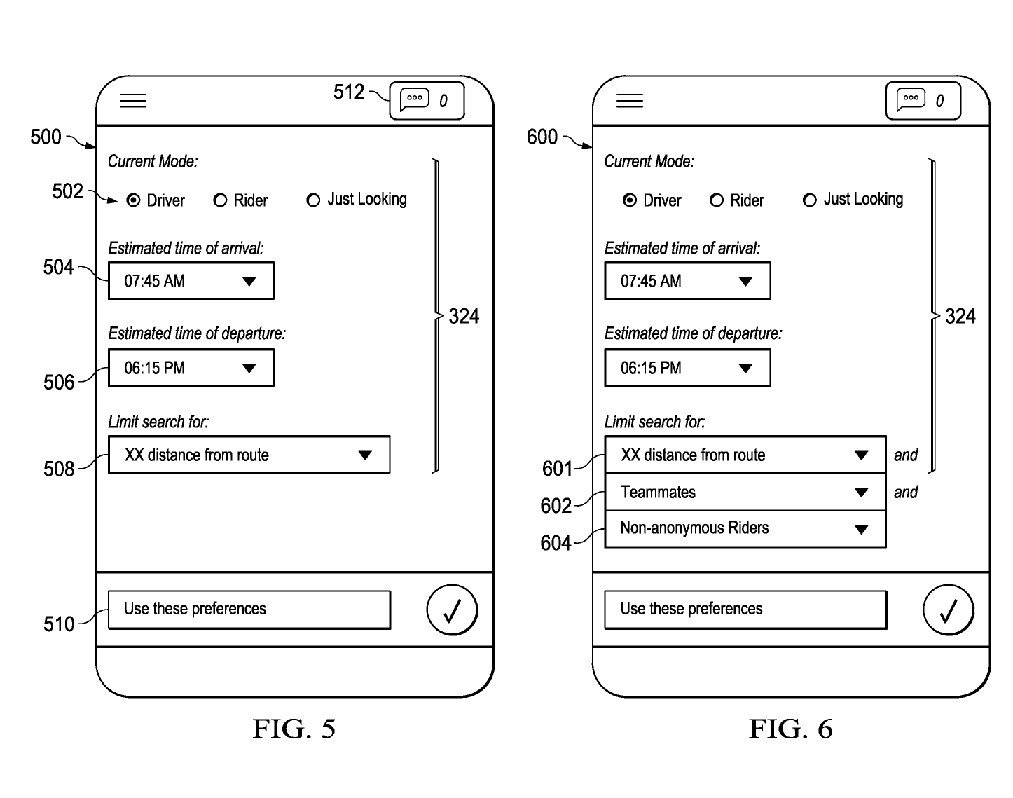

Turning to FIG. 5, an illustration of a graphical user interface for specifying a search for ride sharing opportunities is depicted in accordance with an illustrative embodiment. Graphical user interface 500 is an example of a graphical user interface shown in block form in at least one of graphical user interfaces 140 in FIG. 1, graphical user interface 210 in FIG. 2, or set of graphical user interfaces 222 in FIG. 2.

As depicted, user input has been received in graphical user interface 500 to set preferences for establishing ride sharing 324 for an employee. In this illustrative example, preferences for establishing ride sharing 324 include preference 502 for identification of the employee as at least one of a driver, a rider, or just looking; preference 504 for estimating the time of arrival at the destination of route 112; preference 506 for estimating the time to depart for route 112; and preference 508 for selecting distance 134 from route 112 in FIG. 1. As depicted, the employee has selected to be the driver of the vehicle for route 112 and limit the search for riders to riders who are selected distance 134 from route 112.

In this illustrative example, selecting button 510 sends preferences for establishing ride sharing 324 for the employee to coordinator 120 in FIG. 1. For example, after preferences for establishing ride sharing 324 for the employee are sent to coordinator 120, the employee is allowed to continue past graphical user interface 500 to establish ride sharing.

As depicted, indicator 512 displays whether messages are available for the employee. In this illustrative example, user input selecting indicator 512 may display messages that have been sent to the employee.

Turning next to FIG. 6, an illustration of a graphical user interface for specifying a search for ride sharing opportunities is depicted in accordance with an illustrative embodiment. Graphical user interface 600 is an example of a graphical user interface shown in block form in at least one of graphical user interfaces 140 in FIG. 1, graphical user interface 210 in FIG. 2, or set of graphical user interfaces 222 in FIG. 2.

As depicted, user input has been received in graphical user interface 600 to set preferences for establishing ride sharing 324 for an employee. In this illustrative example, preferences for establishing ride sharing 324 include preference 601 for selecting distance 134 from route 112 in FIG. 1, preference for selecting teammates to ride with 602, and preference for selecting non-anonymous riders 604. As depicted, the employee has selected to be the driver of the vehicle for route 112 and limit the search for riders to riders who are selected distance 134 from route 112, and who are teammates of the employee, and who have not selected preferences to keep a portion of their employee information anonymous.

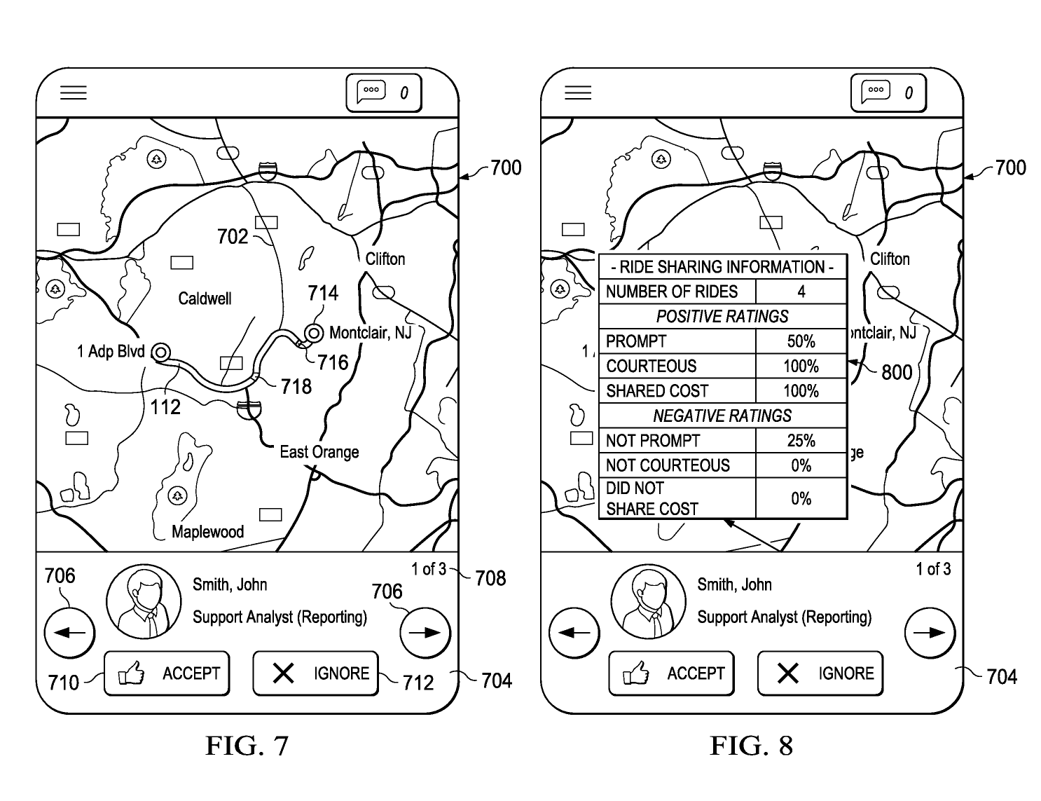

Turning now to FIG. 7, an illustration of a graphical user interface for selecting a set of riders for a ride sharing opportunity is depicted in accordance with an illustrative embodiment. Graphical user interface 700 is an example of a graphical user interface shown in block form in at least one of graphical user interfaces 140 in FIG. 1, graphical user interface 210 in FIG. 2, or set of graphical user interfaces 222 in FIG. 2.

As depicted, route 112 on map 702 for a ride sharing opportunity is displayed in graphical user interface 700. In this illustrative example, potential riders window 704 in graphical user interface 700 displays portions of potential rider information 208 in FIG. 2.

In the illustrative example, portions of potential rider information 208 displayed in potential riders window 704 include at least one of the name of a potential rider, the title of the potential rider, or organizational structure name of the potential rider. The organizational structure name of the potential rider is the name of an organizational structure in organization 102 selected from at least one of a department, project, division, committee, or other type of organizational structure in organization 102 where employees 104 in FIG. 1 work with each other.

As depicted, selecting navigation buttons 706 switches between a number of identified potential riders. As also depicted, indicator 708 displays which of the number of potential riders is currently being displayed in potential riders window 704.

In this illustrative example, user input selecting accept button 710 sends an indication to coordinator 120 that the employee has accepted the displayed potential rider as a rider for route 112 in FIG. 1. User input selecting ignore button 712 sends an indication to coordinator 120 that the employee has not accepted the displayed potential rider as a rider for route 112.

As depicted, location 714, location 716, and location 718 are potential locations for riders to board the vehicle along the route. For example, location 714 may be the location where the driver will start the route. In this example, location 716 and location 718 are examples of locations along the route that the driver may pick up or drop off riders.

With reference now to FIG. 8, an illustration of a graphical user interface for displaying ride sharing information about a rider is depicted in accordance with an illustrative embodiment. Graphical user interface 700 shown in FIG. 8 shows an additional window for displaying ride sharing information for graphical user interface 700 shown in FIG. 7.

In this illustrative example, graphical user interface 700 includes table of ride sharing information 800 about a rider currently displayed in potential riders window 704. As depicted, table of ride sharing information 800 for the rider includes at least one of the number of rides the rider has participated in, the positive ratings for the rider, or the negative ratings for the rider. In this illustrative example, table of ride sharing information 800 is generated from route information 202 in FIG. 2.

As depicted, the positive ratings for the rider may include a percentage of times the rider was reported to be at least one of prompt, courteous, or shared costs. As also depicted, the negative ratings for the rider may include a percentage of times the rider was reported to have not been at least one of prompt, courteous, or shared costs.

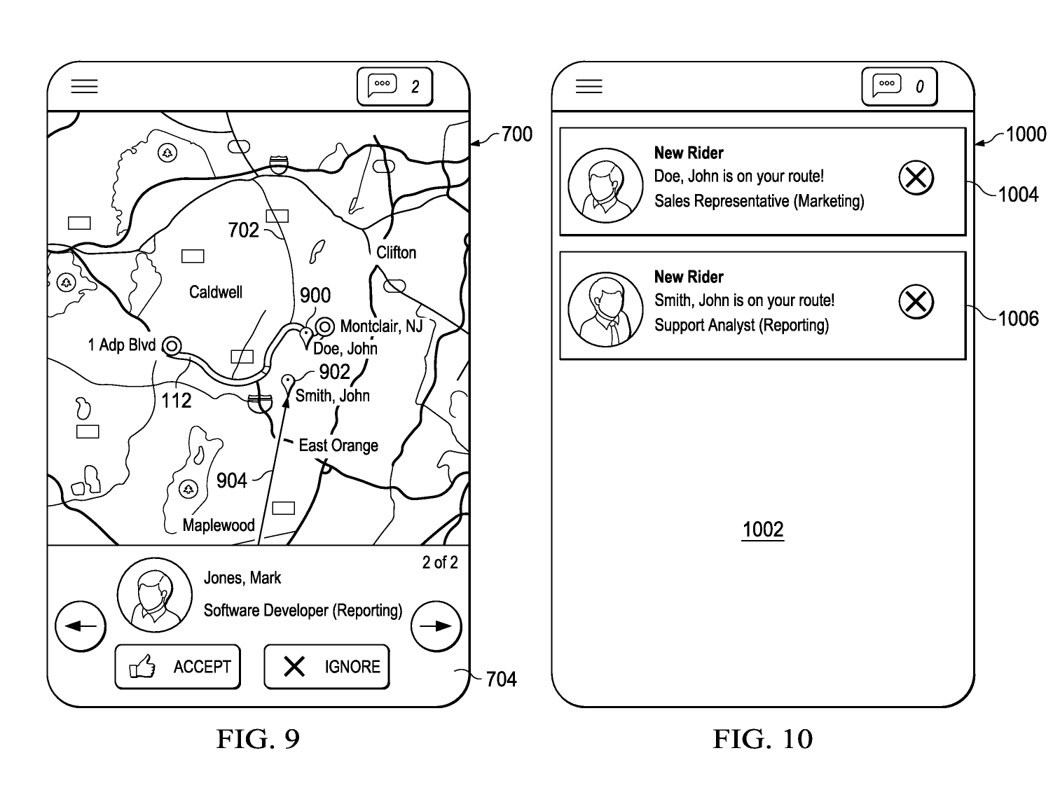

With reference next to FIG. 9, an illustration of a graphical user interface for displaying locations of potential riders is depicted in accordance with an illustrative embodiment. Graphical user interface 700 shown in FIG. 9 shows indicators for locations of potential riders as added to graphical user interface 700 shown in FIG. 7.

In this illustrative example, graphical user interface 700 includes location indicator 900 of a first potential rider and location indicator 902 of a second potential rider. In the illustrative example, the first potential rider and the second potential rider have been selected for ride sharing of a vehicle along route 112. As depicted, arrow indicator 904 shows that location indicator 902 is for the second potential rider currently being displayed in potential riders window 704 in graphical user interface 700.

Turning to FIG. 10, an illustration of a graphical user interface for displaying messages is depicted in accordance with an illustrative embodiment. Graphical user interface 1000 is an example of a graphical user interface shown in block form in at least one of graphical user interfaces 140 in FIG. 1, graphical user interface 210 in FIG. 2, or set of graphical user interfaces 222 in FIG. 2.

As depicted, graphical user interface 1000 includes list of messages 1002. List of messages 1002 includes at least one of confirmation information 230 in FIG. 2 or messages 232 in FIG. 2. In this illustrative example, list of messages 1002 includes message 1004 and message 1006. In this illustrative example, message 1004 shows that John Doe has accepted to be on route 112. Message 1004 also shows that John Doe is a sales representative that is a member of the marketing team. As depicted, message 1006 shows that John Smith has accepted to be on route 112. Message 1006 also shows that John Smith is a support analyst that is a member of the reporting team.

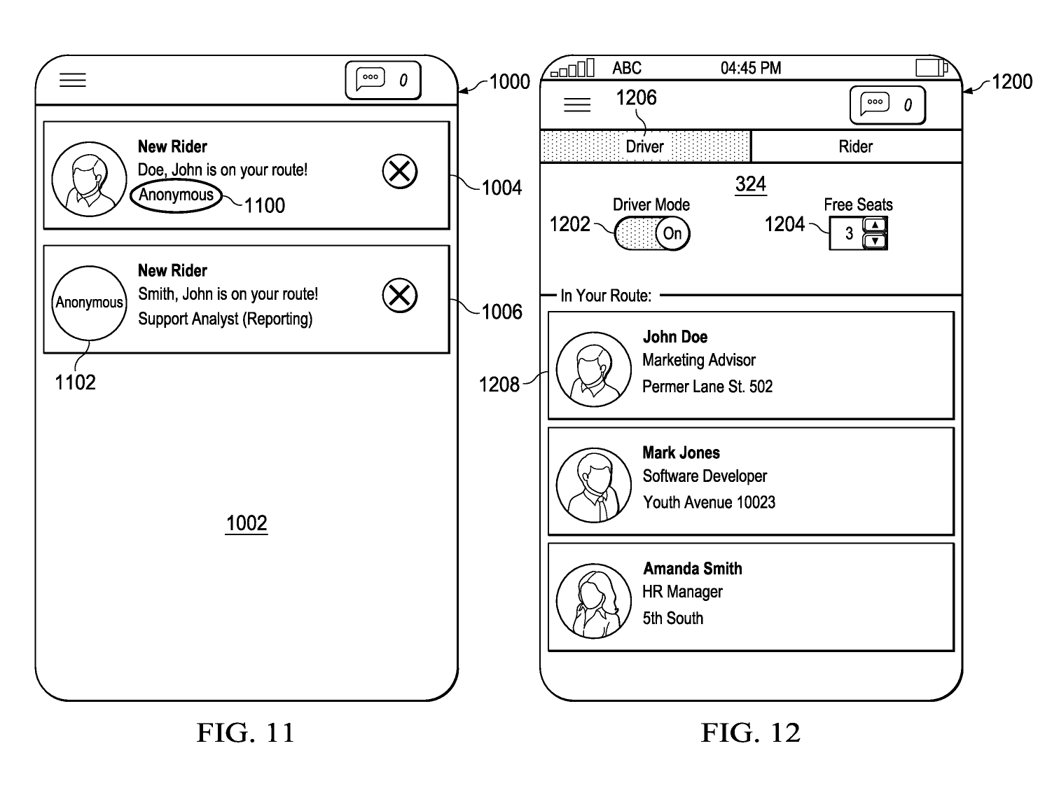

Turning to FIG. 11, an illustration of a graphical user interface for displaying messages is depicted in accordance with an illustrative embodiment. Graphical user interface 1000 in FIG. 11 shows portions of information displayed in list of messages 1002 in FIG. 10 as anonymous portions.

In this illustrative example, message 1004 includes anonymous portion 1100. Anonymous portion 1100 shows that John Doe has selected his job title and team name to be anonymous. As depicted, message 1006 includes anonymous portion 1102. Anonymous portion 1102 shows that John Smith has selected his photo to be anonymous. As depicted, anonymous portion 1100 and anonymous portion 1102 are indicators that block out the types of information selected to be anonymous by the employee.

Turning next to FIG. 12, an illustration of a graphical user interface for managing ride sharing opportunities is depicted in accordance with an illustrative embodiment. Graphical user interface 1200 is another example of a graphical user interface shown in block form in at least one of graphical user interfaces 140 in FIG. 1, graphical user interface 210 in FIG. 2, or set of graphical user interfaces 222 in FIG. 2.

As depicted, user input has been received in graphical user interface 1200 to set preferences for establishing ride sharing 324 for an employee. In this illustrative example, preferences for establishing ride sharing 324 include preference 1202 for identification of the employee as at least one of a driver or rider and preference 1204 for selecting the number of free seats available in a vehicle for route 112 in FIG. 1.

In this illustrative example, the employee has selected to be the driver of the vehicle for route 112 and limit the search for riders to three (3) riders for three (3) seats. As depicted, preferences for establishing ride sharing 324 for the employee may be based on whether the employee has selected to be the driver or a rider. In this illustrative example, preferences for establishing ride sharing 324 are preferences for the driver 1206.

As depicted, potential riders 1208 are displayed in graphical user interface 1200. Potential riders 1208 is an example of potential riders 122 shown in block diagram form in FIG. 1 for route 112 for driver 118 of vehicle 110 in FIG. 1. In this illustrative example, user input may be received to confirm a set of potential riders from potential riders 1208. For example, the user input may comprise a swipe to the right over a rider to send the rider an invite, a swipe to the left over the rider to ignore the rider, or a selection of the rider to at least one of display information about the rider or start a chat with the rider.

As used herein, a swipe is a type of user input performed by a user. The user input for the swipe is from at least one user input system in user input systems 144 in FIG. 1. A swipe is defined as user input comprising a direction of movement of the user input. For example, when a finger is moved from one side of a rider in potential riders 1208 to another side of the rider, the movement is identified as a swipe in graphical user interface 1200.

The illustration of the graphical user interfaces in FIGS. 4-12 are not meant to limit the manner in which graphical user interfaces may be implemented in the different illustrative embodiments. For example, preference 502 in graphical user interface 500 may omit “just looking” and only provide “driver” and “rider” as selections in preference 502. In other illustrative examples, the graphical user interfaces may have a different layout suitable for different types of data processing systems. Further, and in yet another illustrative example, map 702 may be displayed using a satellite image in addition to or in combination with the map view shown in FIG. 7. In still other illustrative examples, the graphical user interfaces may include graphical controls for a messaging feature.

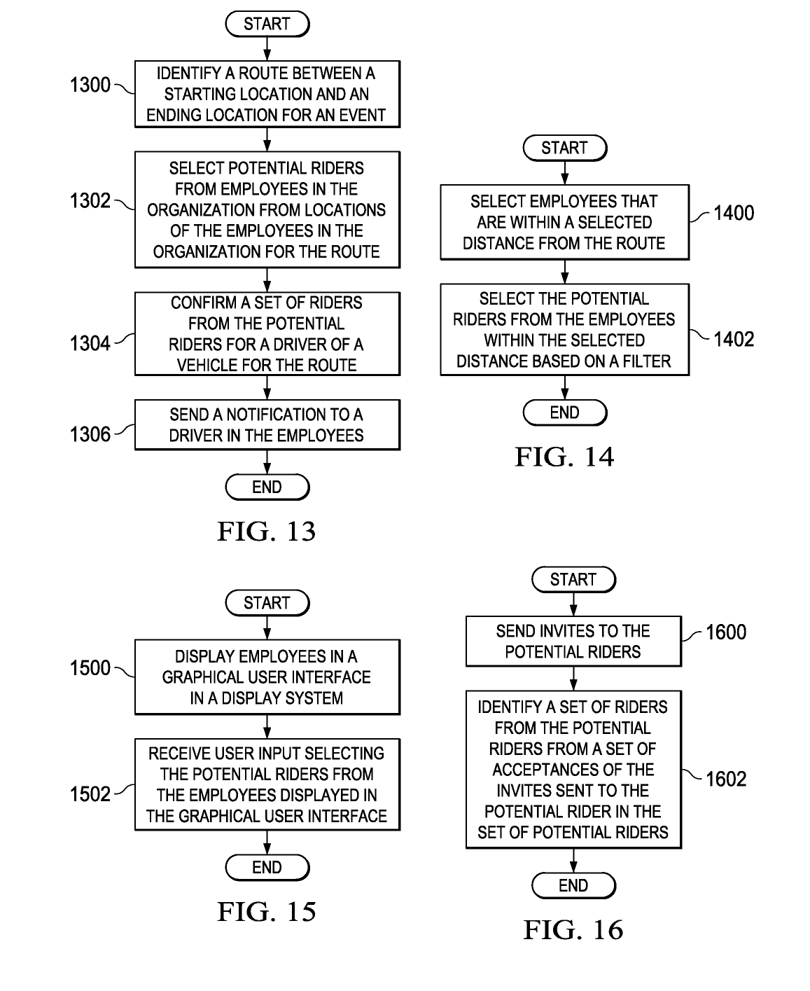

Turning next to FIG. 13, an illustration of a flowchart of a process for coordinating ride sharing is depicted in accordance with an illustrative embodiment. The process illustrated in FIG. 13 may be implemented in computer system 124. In particular, one or more of the different steps may be implemented using coordinator 120 in FIG. 1.

The process begins by identifying a route between a starting location and an ending location for an event (step 1300). The process then selects potential riders from employees in the organization from locations of the employees in the organization for the route (step 1302). The potential riders selected in step 1302 are employees that will attend the event.

The process confirms a set of riders from the potential riders for a driver of a vehicle for the route (step 1304). The process sends a notification to a driver in the employees (step 1306), with the process terminating thereafter. The notification identifies a set of riders for the route from the set of potential riders.

Turning now to FIG. 14, an illustration of a flowchart of a process for selecting potential riders is depicted in accordance with an illustrative embodiment. The process illustrated in FIG. 14 is an example of an implementation for step 1302 in FIG. 13.

The process begins by selecting employees that are within a selected distance from the route (step 1400). The selected distance from the route may be a selected distance from at least one of the starting location, the ending location, or the path between the starting location and the ending location.

For example, it may be desirable to have employees within a selected distance from where the ride sharing will begin. In other illustrative examples, stops may be made and the selection of employees may be made based on being a selected distance from those potential stops along the path for the route. In other illustrative examples, the employees may be selected based on how far the employees are from the ending location of the route. If the employees are closer than some selected distance from the ending location, including those employees as potential riders may be impractical.

The process then selects the potential riders from the employees within the selected distance based on a filter (step 1402). The filter may filter employees based on one or more preferences. For example, the filter may identify employees in step 1402 as potential riders if the employees have one or more characteristics. For example, the filter may look for employees that are teammates. In another illustrative example, the filter may look for employees that are non-smokers, like coffee, or some other suitable characteristic.

Turning now to FIG. 15, an illustration of a flowchart of a process for selecting potential riders is depicted in accordance with an illustrative embodiment. The process illustrated in FIG. 15 is an example of another implementation for step 1302 in FIG. 13.

The process begins by displaying employees in a graphical user interface in a display system (step 1500). The employees displayed in the graphical user interface are employees that are currently within a selected distance from the route. These employees may also be ones that are teammates.

The process then receives user input selecting the potential riders from the employees displayed in the graphical user interface (step 1502) with the process terminating thereafter. The user input may be from a driver or some other user.

With reference now to FIG. 16, an illustration of a flowchart of a process for confirming a set of riders from potential riders is depicted in accordance with an illustrative embodiment. The process illustrated in FIG. 16 is an example of one implementation for step 1304 in FIG. 13.

The process begins by sending invites to the potential riders (step 1600). These invites are sent to data processing systems used by the potential riders. The invites may be displayed in a graphical user interface to the potential riders. The process then identifies a set of riders from the potential riders from a set of acceptances of the invites sent to the potential rider in the set of potential riders (step 1602) with the process terminating thereafter.

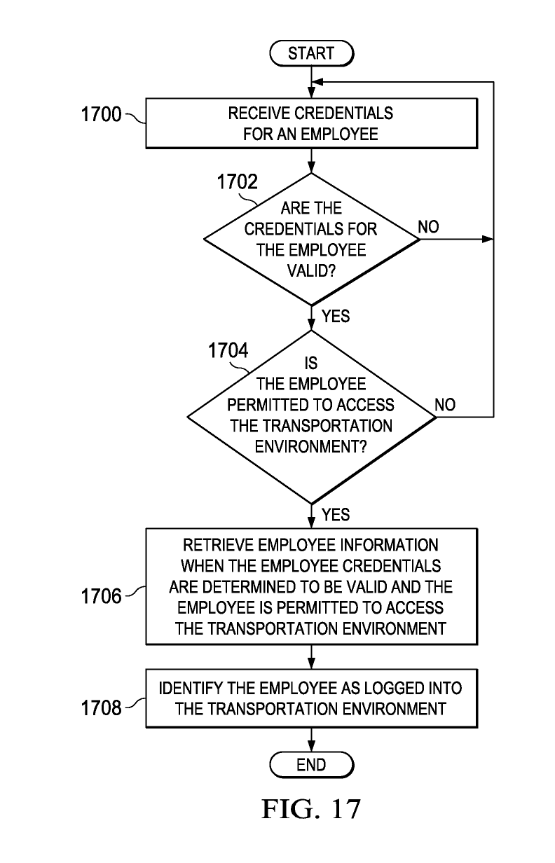

Turning to FIG. 17, an illustration of a flowchart of a process for logging in an employee to a transportation environment is depicted in accordance with an illustrative embodiment. The process illustrated in FIG. 17 may be implemented in computer system 124. In particular, one or more of the different steps may be implemented using coordinator 120 in FIG. 1.

The process begins by receiving credentials for an employee (step 1700). The credentials in step 1700 are information about the employee that identifies the employee as a user of transportation environment 100 in FIG. 1. As used herein, credentials for an employee are data that identify the employee. More particularly, credentials for an employee include security information for the employee. The security information in the credentials is at least one of information that only the employee knows or biometric information that only the employee can provide. For example, the credentials may include a user name and password for the employee.

A determination is then made as to whether the credentials for the employee are valid (step 1702). For example, coordinator 120 may validate the credentials for the employee by at least one of using an application programming interface for validating credentials of employees 104 of organization 102 in FIG. 1 or comparing the credentials against employee information 206 stored in ride sharing database 200 in FIG. 2. If the credentials are not valid, the process returns to step 1700.

As depicted, if the credentials are valid, the process then determines whether the employee is permitted to access the transportation environment (step 1704). For example, coordinator 120 may determine whether the employee is permitted to access transportation environment 100 by at least one of using an application programming interface for validating access to transportation environment 100 for employees 104 of organization 102 in FIG. 1 or comparing permissions stored in employee information 206 in FIG. 2 for employees 104 to access transportation environment 100. If the employee is not permitted to access transportation environment 100, the process returns to step 1700.

The process retrieves employee information when the employee credentials are determined to be valid and the employee is permitted to access the transportation environment (step 1706). The process then identifies the employee as logged into the transportation environment (step 1708) with the process terminating thereafter. For example, coordinator 120 may identify the employee as logged into transportation environment 100 for at least one of receiving messages or establishing ride sharing in transportation environment 100.

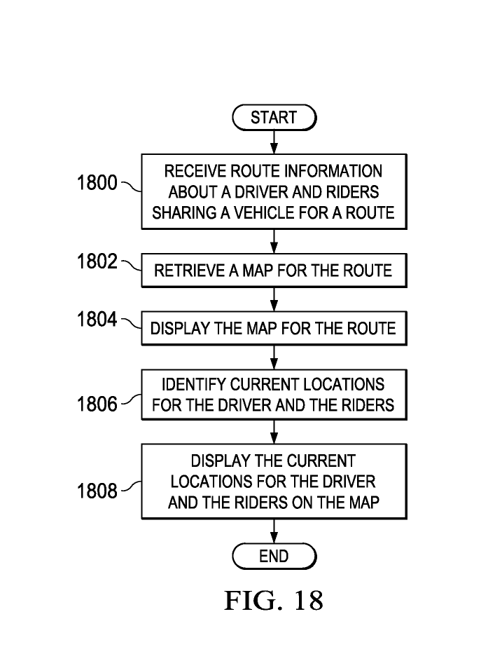

Turning next to FIG. 18, an illustration of a flowchart of a process for displaying route information is depicted in accordance with an illustrative embodiment. The process illustrated in FIG. 18 may be implemented in computer system 124. In particular, one or more of the different steps may be implemented using coordinator 120.

The process begins by receiving route information about a driver and riders sharing a vehicle for a route (step 1800). The process then retrieves a map for the route (step 1802). The process next displays the map for the route (step 1804). The process identifies current locations for the driver and the riders (step 1806). The process then displays the current locations for the driver and the riders on the map (step 1808) with the process terminating thereafter.

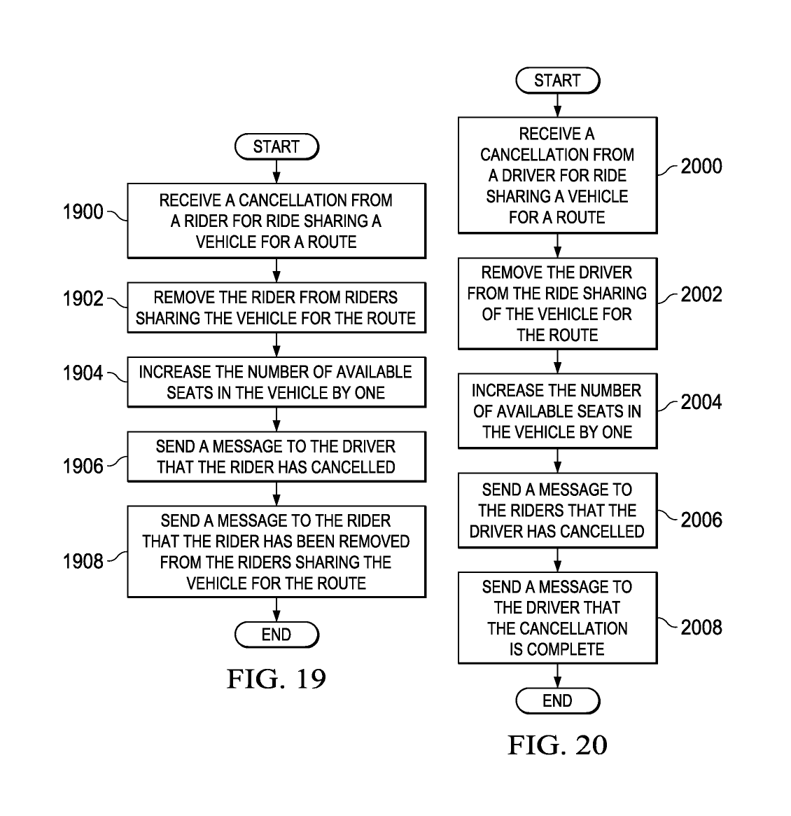

Turning next to FIG. 19, an illustration of a flowchart of a process for cancelling ride sharing for a rider is depicted in accordance with an illustrative embodiment. The process illustrated in FIG. 19 may be implemented in computer system 124 in FIG. 1. In particular, one or more of the different steps may be implemented using coordinator 120.

The process begins by receiving a cancellation from a rider for ride sharing a vehicle for a route (step 1900). The process removes the rider from riders sharing the vehicle for the route (step 1902). The process increases the number of available seats in the vehicle by one (step 1904). The process sends a message to the driver that the rider has cancelled (step 1906). The process then sends a message to the rider that the rider has been removed from the riders sharing the vehicle for the route (step 1908) with the process terminating thereafter. With reference again to step 1900, the cancellation may be also stored to indicate a number of times the rider has cancelled. When the number of times the rider has cancelled has been stored, the number of cancellations made by an employee may be displayed to the driver when the driver is choosing from potential riders.

With reference now to FIG. 20, an illustration of a flowchart of a process for cancelling ride sharing for a driver is depicted in accordance with an illustrative embodiment. The process illustrated in FIG. 20 may be implemented in computer system 124 in FIG. 1. In particular, one or more of the different steps may be implemented using coordinator 120.

The process begins by receiving a cancellation from a driver for ride sharing a vehicle for a route (step 2000). The process removes the driver from the ride sharing of the vehicle for the route (step 2002). The process increases the number of available seats in the vehicle by one (step 2004). The process sends a message to the riders that the driver has cancelled (step 2006). The process then sends a message to the driver that the cancellation is complete (step 2008) with the process terminating thereafter. With reference again to step 2000, the cancellation may be also stored to indicate a number of times the driver has cancelled. When the number of times the driver has cancelled has been stored, the number of cancellations made by the driver may be displayed to the riders when the riders are choosing to accept an invite from the driver.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, the different steps shown for selecting potential riders in FIG. 14 and FIG. 15 may be combined to select potential riders from employees based on distance, and a filter. Then these employees may be presented to a user for selection by the user.

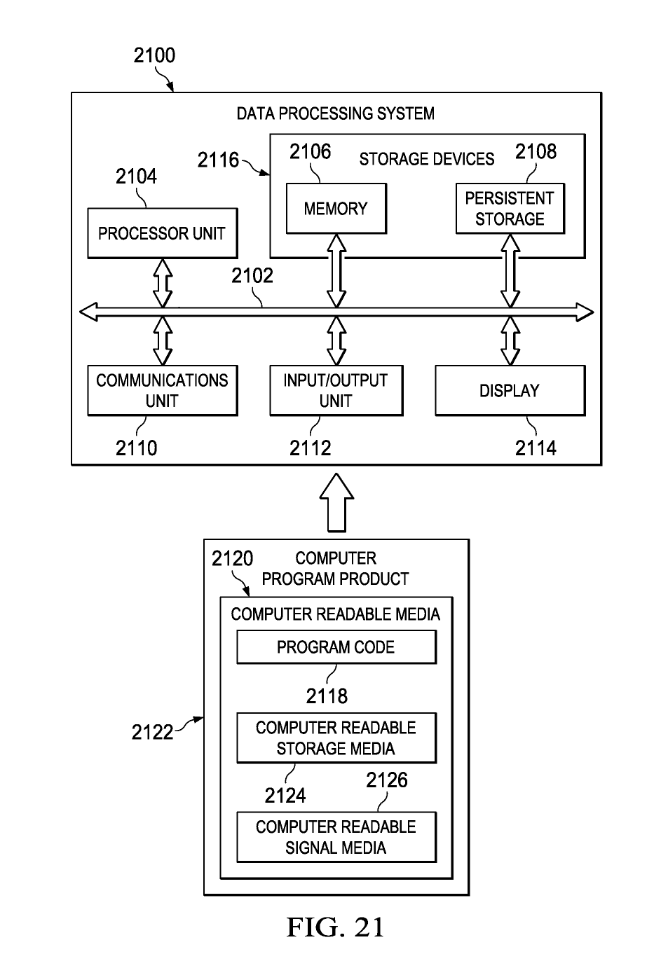

Turning now to FIG. 21, an illustration of a block diagram of a data processing system is depicted in accordance with an illustrative embodiment. Data processing system 2100 may be used to implement a data processing system in computer system 124 in FIG. 1. In particular, data processing system 2100 may be used to implement at least one of data processing systems 136 in FIG. 1, data processing system 204 in FIG. 2, or set of data processing systems 220 in FIG. 2. In this illustrative example, data processing system 2100 includes communications framework 2102, which provides communications between processor unit 2104, memory 2106, persistent storage 2108, communications unit 2110, input/output (I/O) unit 2112, and display 2114. In this example, communication framework may take the form of a bus system.

Processor unit 2104 serves to execute instructions for software that may be loaded into memory 2106. Processor unit 2104 may be a number of processors, a multi-processor core, or some other type of processor, depending on the particular implementation.

Memory 2106 and persistent storage 2108 are examples of storage devices 2116. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 2116 may also be referred to as computer readable storage devices in these illustrative examples. Memory 2106, in these examples, may be, for example, a random access memory or any other suitable volatile or non-volatile storage device. Persistent storage 2108 may take various forms, depending on the particular implementation.

For example, persistent storage 2108 may contain one or more components or devices. For example, persistent storage 2108 may be a hard drive, a flash memory, a rewritable optical disk, a rewritable magnetic tape, or some combination of the above. The media used by persistent storage 2108 also may be removable. For example, a removable hard drive may be used for persistent storage 2108.

Communications unit 2110, in these illustrative examples, provides for communications with other data processing systems or devices. In these illustrative examples, communications unit 2110 is a network interface card.

Input/output unit 2112 allows for input and output of data with other devices that may be connected to data processing system 2100. For example, input/output unit 2112 may provide a connection for user input through at least of a keyboard, a mouse, or some other suitable input device. Further, input/output unit 2112 may send output to a printer. Display 2114 provides a mechanism to display information to a user.

Instructions for at least one of the operating system, applications, or programs may be located in storage devices 2116, which are in communication with processor unit 2104 through communications framework 2102. The processes of the different embodiments may be performed by processor unit 2104 using computer-implemented instructions, which may be located in a memory, such as memory 2106.

These instructions are referred to as program code, computer usable program code, or computer readable program code that may be read and executed by a processor in processor unit 2104. The program code in the different embodiments may be embodied on different physical or computer readable storage media, such as memory 2106 or persistent storage 2108.

Program code 2118 is located in a functional form on computer readable media 2120 that is selectively removable and may be loaded onto or transferred to data processing system 2100 for execution by processor unit 2104. Program code 2118 and computer readable media 2120 form computer program product 2122 in these illustrative examples. In one example, computer readable media 2120 may be computer readable storage media 2124 or computer readable signal media 2126. In these illustrative examples, computer readable storage media 2124 is a physical or tangible storage device used to store program code 2118 rather than a medium that propagates or transmits program code 2118.

Alternatively, program code 2118 may be transferred to data processing system 2100 using computer readable signal media 2126. Computer readable signal media 2126 may be, for example, a propagated data signal containing program code 2118. For example, computer readable signal media 2126 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 2100 are not meant to provide architectural limitations to the manner in which different embodiments may be implemented. The different illustrative embodiments may be implemented in a data processing system including components in addition to or in place of those illustrated for data processing system 2100. Other components shown in FIG. 21 can be varied from the illustrative examples shown. The different embodiments may be implemented using any hardware device or system capable of running program code 2118.

Thus, one or more of the illustrative examples provide a method and apparatus for coordinating ride sharing between employees. In the illustrative examples, a coordinator in a computer system identifies a route between a starting location and an ending location for an event. The coordinator selects potential riders from employees in the organization from locations of the employees in organization for the route. The potential riders will attend the event. The coordinator also confirms a set of riders from the potential riders for a driver of a vehicle for the route.

Using a coordinator as depicted in the illustrative examples, coordinating ride sharing may occur more easily and with increased comfort with respect to riders. In the illustrative examples, the potential riders are selected as employees of the company. Other people are not included in the pool of potential riders. In this manner, the driver and riders for ride sharing may have a higher level of comfort and security knowing that riders in the ride sharing for a route are employees of an organization. In other illustrative examples, the potential riders may be employees of two or more organizations.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for coordinating ride sharing comprising:
identifying, by a computer system, a route between a starting location and an ending location for an event;
selecting, by the computer system, potential riders from employees in an organization from locations of the employees in the organization for the route, wherein the potential riders will attend the event; and
confirming, by the computer system, a set of riders from the potential riders for a driver of a vehicle in the employees for the route.

2. The method of claim 1 further comprising:
sending, by the computer system, a notification to the driver, wherein the notification identifies the set of riders for the route from the potential riders.

3. The method of claim 1, wherein the selecting step further comprises:
selecting the potential riders from the employees that are within a selected distance from the route and are teammates who work together.

4. The method of claim 1, wherein the confirming step comprises:
sending invites to the potential riders; and
identifying the set of riders from the potential riders from a set of acceptances of the invites sent to the potential riders.

5. The method of claim 1, wherein the selecting step comprises:
displaying the employees in a graphical user interface in a display system, wherein the employees are currently within a selected distance from the route and are teammates; and
receiving user input for selecting the potential riders from the employees displayed in the graphical user interface.

6. The method of claim 1, wherein a portion of the potential riders have a preference to keep information anonymous for at least one of employee identification, name, photo, home address, work address, manager, job title, or company identification.

7. The method of claim 6, wherein confirming, by the computer system, the set of riders from the potential riders for the driver of the vehicle for the route comprises:
receiving user input from the driver for selecting between the portion of the potential riders and another portion of the potential riders not in the portion of the potential riders having the preference to keep the information anonymous.

8. The method of claim 1 further comprising:
receiving, by the computer system, a cancellation for sharing transportation along the route from at least one of the driver and a rider in the set of riders; and
storing, by the computer system, the cancellation for use in coordinating the sharing of the transportation.

9. The method of claim 1, wherein confirming, by the computer system, the set of riders from the potential riders for the driver of the vehicle for the route comprises:
notifying at least one of the driver or the set of riders about a number of cancellations by the at least one of the driver or the set of riders.

10. The method of claim 1, wherein the potential riders are teammates who work together.

11. The method of claim 1, wherein the location is a current location of the employees.

12. A computer system comprising:
a coordinator in the computer system, wherein the coordinator identifies a route between a starting location and an ending location for an event; selects potential riders from employees in an organization from locations of the employees in the organization for the route, wherein the potential riders will attend the event; and confirms a set of riders from the potential riders for a driver of a vehicle in the employees for the route.

13. The computer system of claim 12, wherein the coordinator sends a notification to the driver, wherein the notification identifies the set of riders for the route from the potential riders.

14. The computer system of claim 12, wherein in selecting the potential riders from the employees in the organization from the locations of the employees in the organization for the route, the coordinator selects the potential riders from the employees that are within a selected distance from the route and are teammates who work together.

15. The computer system of claim 12, wherein in confirming the set of riders from the potential riders for the driver of the vehicle for the route, the coordinator sends invites to the potential riders; and identifies the set of riders from the potential riders from a set of acceptances of the invites sent to the potential riders.

16. The computer system of claim 12, wherein in selecting the potential riders from the employees in the organization from the locations of the employees in the organization for the route, the coordinator displays the employees in a graphical user interface in a display system, wherein the employees are currently within a selected distance from the route and are teammates who work together; and receives user input selecting the potential riders from the employees displayed in the graphical user interface.

17. The computer system of claim 12, wherein a portion of the potential riders have a preference to keep information anonymous for at least one of employee identification, name, photo, home address, work address, manager, job title, or company identification.

18. The computer system of claim 17, wherein in confirming the set of riders from the potential riders for the driver of the vehicle for the route, the coordinator receives user input from the driver for selecting between the portion of potential riders and another portion of the potential riders not in the portion of the potential riders having the preference to keep information anonymous.

19. The computer system of claim 12, wherein the coordinator receives a cancellation for sharing transportation along the route from at least one of the driver and a rider in the set of riders and stores the cancellation for use in coordinating the sharing of the transportation.

20. The computer system of claim 12, wherein in confirming the set of riders from the potential riders for the driver of the vehicle for the route, the coordinator notifies at least one of the driver or the set of riders about a number of cancellations by at least one of the driver or the set of riders.

21. A computer program product for coordinating ride sharing, the computer program product comprising:
a computer readable storage media;
first program code, stored on the computer readable storage media, for identifying a route between a starting location and an ending location for an event;
second program code, stored on the computer readable storage media, for selecting potential riders from employees in an organization from locations of the employees in the organization for the route, wherein the potential riders are teammates who work together and will attend the event; and
third program code, stored on the computer readable storage media, for confirming a set of riders from the potential riders for a driver of a vehicle in the employees for the route.
